(19) United States
(12) Patent Application Publication
(10) Pub. No.: US 2006/0190246 A1
(43) Pub. Date: Aug. 24, 2006

(54) Transcoding method for switching between selectable mode voice encoder and an enhanced variable rate CODEC

(75) Inventor: Youngho Park, San Diego, CA (US)

Correspondence Address: CHRISTOPHER P. MAIORANA, P.C., 24840 HARPER SUITE 100, ST. CLAIR SHORES, MI, 48080, US

(73) Assignee: VIA TELECOM CO., LTD.

(21) Appl. No.: 11/064,179

(22) Filed: Feb. 23, 2005

(51) Int. Cl. G10L 19/12

(52) U.S. Cl. 704/221

(57) ABSTRACT

An apparatus comprising an encoder circuit and a transcoder circuit. The encoder circuit may be configured to generate a bitstream comprising a series of packets in response to a speech input signal. The transcoder circuit may be configured to generate an intermediate bitstream in response to the bitstream. The transcoder (a) implements (i) a first encoding type comprising a selectable mode voice (SMV) encoding or (ii) a second encoding type comprising an enhanced variable rate (EVR) encoding in response to a type of data in each of the packets of the bitstream and (b) the first or second encoding type is selected on a per packet basis.

### FIELD OF THE INVENTION

The present invention relates to a method and/or architecture for transcoding generally and, more particularly, to a transcoding method for switching between a selectable mode voice encoder and an enhanced variable rate CODEC.

### BACKGROUND OF THE INVENTION

FIG. 1 is an example of a system 10 illustrating a conventional tandem transcoding method. The system 10 includes an encoder 12, a decoder 14, an encoder 16 and a decoder 18. Conventional transcoding systems communicate with reconstruction of pulse code modulation (PCM) data. Transcoding with PCM data can sacrifice speech quality and introduce a delay between two different vocoders (voice encoder) when using a direct parameter conversion method. Since two different vocoders may have a different encoding architecture, frame size, sampling rate, and/or codebook contents, it is very difficult to reconstruct a speech signal without a serious speech quality degradation.

### SUMMARY OF THE INVENTION

The present invention concerns an apparatus comprising an encoder circuit and a transcoder circuit. The encoder circuit may be configured to generate a bitstream comprising a series of packets in response to a speech input signal. The transcoder circuit may be configured to generate an intermediate bitstream in response to the bitstream. The transcoder (a) implements (i) a first encoding type comprising a selectable mode voice (SMV) encoding or (ii) a second encoding type comprising an enhanced variable rate (EVR) encoding in response to a type of data in each of the packets of the bitstream and (b) the first or second encoding type is selected on a per packet basis.

The objects, features and advantages of the present invention include providing a transcoding method that may (i) translate between a selectable mode and an enhanced variable rate CODEC (ii) improve speech quality, and/or (iii) reduce delays.

### BRIEF DESCRIPTION OF THE DRAWINGS

These and other objects, features and advantages of the present invention will be apparent from the following detailed description and the appended claims and drawings in which:

FIG. 1 is a diagram illustrating a conventional tandem coding method;

FIG. 2 is a diagram illustrating a context of the present invention;

FIG. 3 is a block diagram comparing a conventional approach (A) with a preferred embodiment of the present invention (B);

FIG. 4 is a block diagram of the SMV decoder of FIG. 3;

FIG. 5 is a block diagram of a EVRC/SMV decoder using a transcoding block;

FIG. 6 is a timing diagram showing the alignment of a residual signal frame between an SMV with four subframes and an EVRC with three subframes;

FIG. 7 is a diagram of a type selection method;

FIG. 8 is a two dimensional plot of a type 0 and a type 1 frame;

FIG. 9 is a flow diagram of an SMV encoder with a transcoding method; and

FIG. 10 is a block diagram of a fixed codebook architecture illustrating an SMV encoder with transcoding.

### DETAILED DESCRIPTION OF THE PREFERRED EMBODIMENTS

The present invention may be useful in a transcoding system where major parameters (e.g., frame size, sampling rate, etc.) of two different voice encoders (vocoders) are similar. An acceptable result may be obtained by slightly sacrificing speech quality. The present invention may provide (i) a transcoded speech quality better than or equal to the speech quality achieved through a conventional tandem method (since selectable mode voice encoding (SMV) has improved rate selection processing), (ii) pitch tracking processing, (iii) noise suppression, and/or (iv) a perceptual weighted coefficient calculation method when compared with an EVRC (enhanced variable rate coder/decoder (CODEC)).

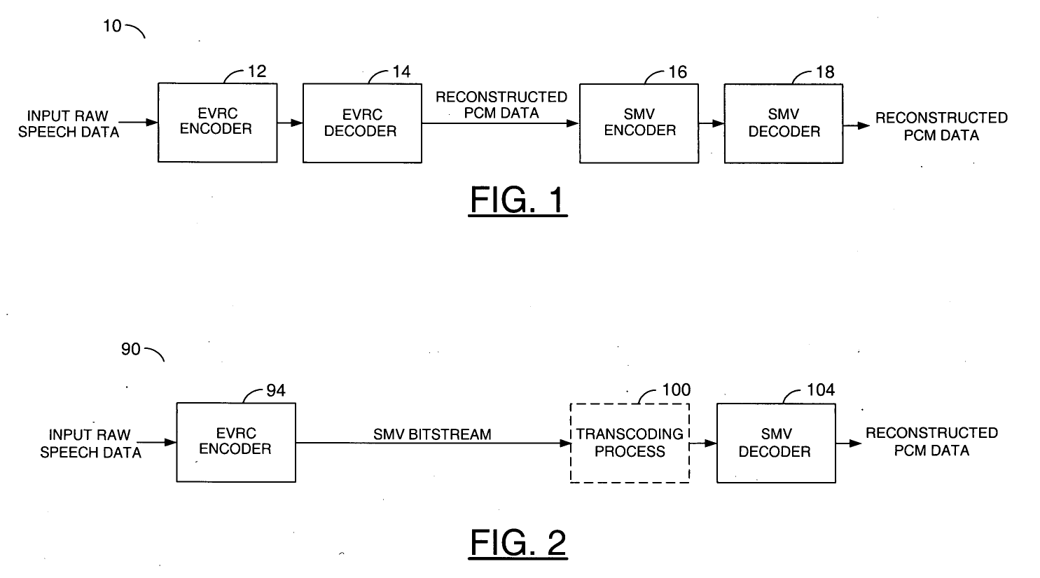

Referring to FIG. 2, a system 90 is shown implementing a context of the present invention. The system 90 generally comprises a block (or circuit) 94, a block (or circuit) 100 and a block (or circuit) 104. The block 94 may be implemented as an EVRC encoder. The block 100 may be implemented as a transcoding processing block. The block 104 may be implemented as an SMV decoder. In general, the block 100 includes both an SMV module and a transcoding logic portion.

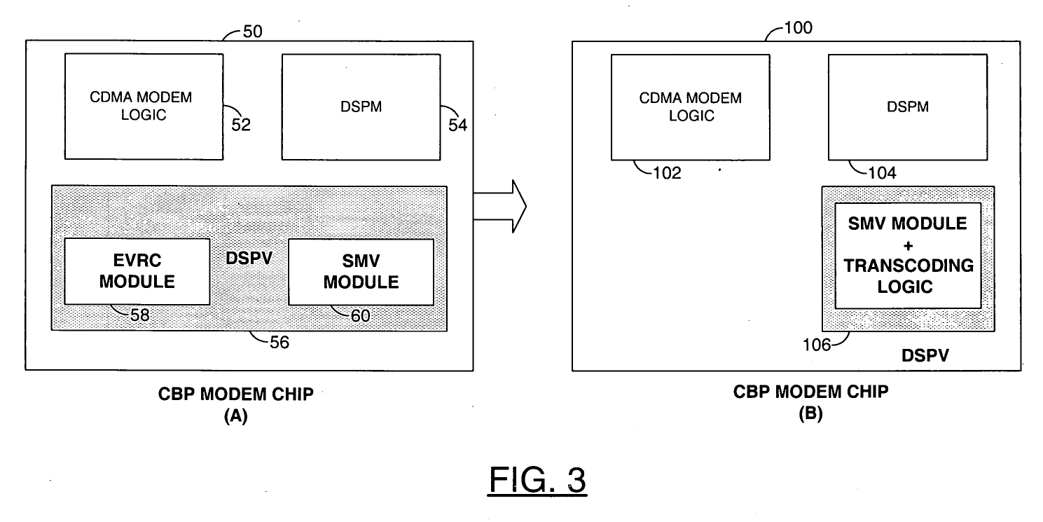

Referring to FIG. 3, a block diagram of a conventional system 50 (FIG. 3A) is shown compared with a system 100 (FIG. 3B). The system 100 illustrates a preferred embodiment of the present invention. The circuit 50 comprises a block (or circuit) 52, a block (or circuit) 54 and a block (or circuit) 56. The block 52 is implemented as a code division multiple access (CDMA) module logic. The block 54 is implemented as a digital signal processing modem (DSPM) block. The block 56 is implemented as digital signal processing voice (DSPV) block. The block 56 includes a block 58 and a block 60. The block 58 is implemented as an EVRC module. The block 60 is implemented as an SMV module.

The system 100 generally comprises a block (or circuit) 102, a block (or circuit) 104 and a block (or circuit) 106. The block 102 may be implemented as a CDMA modem logic block, similar to the block 12. The block 104 may be implemented as a digital signal processing modem (DSPM) block, similar to the block 54. The block 106 may be implemented as a DSPV block. However, the block 106 generally includes both an SMV module and a transcoding logic section. Since the SMV module 60 and the EVRC module 58 have the same frame size, the same sampling rate and the same rate selection structure, the SMV works structurally like a superset of the EVRC block 18.

The system 100 shows the block illustrating the SMV having embedded transcoding logic for the EVRC, which results in a number of advantages. For example, the data ROM/RAM table size and program RAM/ROM size for the system 100 (normally implemented in the block 106, but omitted for clarity) may be reduced. In particular, the amount of EVRC program code and data table (except the line spectrum frequency (LSF) codebook and some program code for parameter quantization) may be reduced. The average transmission rate of the system may be reduced (or an improved speech quality may be realized) when compared with the EVRC implementation of the system 50 because of the improved rate decision method of the SMV.

Speech quality using the system 100 is improved when compared to decoded speech through a conventionally configured EVRC decoder. When the bit stream is transferred from the EVRC encoder to SMV decoder within the block 106, the SMV decoder generates an improved speech quality compared with the EVRC since the SMV decoder has an improved error concealment process and enhanced post filtering. The present invention implements a modified SMV encoder and decoder to implement the transcoding process.

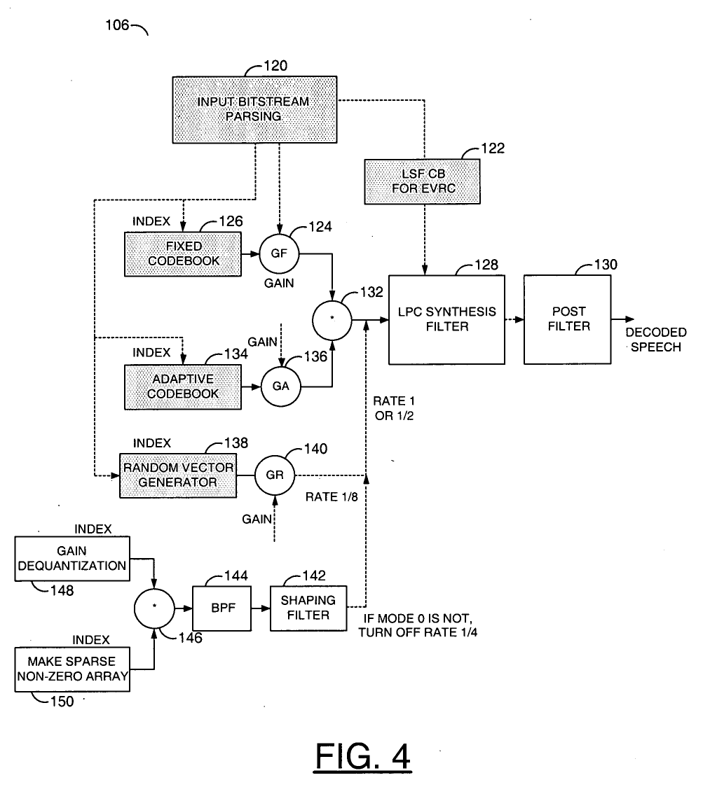

Referring to FIG. 4, a block diagram of the block 106 is shown. The block 106 generally comprises a modified SMV decoder and a modified SMV encoder. The SMV decoder 106 provides an improved performance of the transcoding functionality. The decoder 106 generally includes an input bitstream parsing block (or circuit) 120. The circuit 120 presents a signal to (i) a circuit 122, (ii) a gain block 124 and (iii) a codebook block 126. The circuit 122 may be implemented as an LSF codebook for EVRC. The block 126 may be implemented as a fixed codebook. The block 122 presents a signal to a filter block 128. The filter block 128 may be implemented as a linear predictive coding (LPC) synthesis filter. The block 128 presents a signal to a filter block 130. The filter block 130 may be implemented as a post filter block that presents a decoded speech signal. The gain block 124 generally receives a signal from the circuit 120 as well as a signal from the circuit 126. The gain block 124 presents a signal to a summing block 132. A codebook block 134 may also receive a signal from the circuit 120. The codebook circuit 134 may be implemented as an adaptive codebook that presents a signal to a gain block 136. The gain block 136 presents a signal to the summing circuit 132.

A block 138 also receives a signal from the circuit 120. The circuit 138 may be implemented as a random vector generator block that presents a signal to a gain block 140. The gain block 140 generally presents a signal that gets combined with the signal from a shaping filter 142 and the signal from the summing block 132 to present an input to the circuit 128. A filter block 144 receives the signal from a summing block 146 and presents a signal to the shaping filter 142. The filter 144 may be implemented as a band pass filter. The summing circuit 146 receives a signal from a gain dequantization circuit 148 and another signal from a circuit 150. The circuit 150 may be implemented as a make sparse non-zero array circuit. The shaping filter 142 normally turns off a ¼ rate when in a mode 0 (the system 100 normally operates in a mode 0 or a mode 1). If the mode selection is set to zero, the blocks 148, 150, 144, 146 and 142 are turned off, since SMV encoding in mode 0 and EVRC encoding does not work at rates under ¼ rate. In general, an EVRC vocoder does not have a ¼ rate mode, while an SMV encoder does have a ¼ rate mode. So, the input bitstream parsing block 120 uses EVRC encoded packets, while an SMV decoder with transcoding logic always must turn off when operating under ¼ rate.

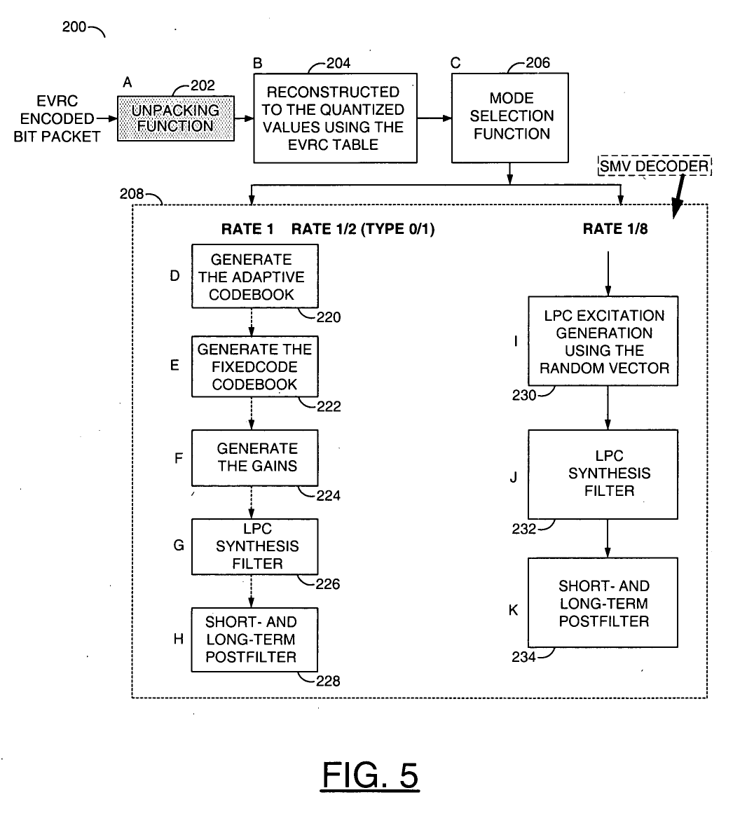

Referring to FIG. 5, a diagram of an EVRC/SMV process 200 is shown. FIG. 5 is a process flow of the block diagram of FIG. 4. The process 200 generally comprises a block (or circuit) 202, a block (or circuit) 204, a block (or circuit) 206 and a block (or circuit) 208. The block 202 may implement an unpacking function. The block 204 may be implemented to reconstruct the quantized values using the EVRC table. The block 206 may be implemented as a mode selection block. The block 208 may be an implementation of an SMV decoder. The block 202 discriminates an encoding vocoder type (e.g., either EVRC or SMV) from the incoming packets, and then un-packs the bits. The block 202 also implements an un-packet structure for the vocoder. If an incoming packet is in EVRC format, the block 202 should operate like an EVRC un-pack block. The block 208 generally comprises a block (or circuit) 220, a block (or circuit) 222, a block (or circuit) 224, a block (or circuit) 226, a block (or circuit) 228, a block (or circuit) 230, a block (or circuit) 232, a block (or circuit) 234.

If an incoming packet comes from the EVRC encoder, the block 204 is turned on. The block 204 makes quantized parameters (e.g., LPC, pitch, codebook indices, and gain) using the EVRC un-pack routine. Three subframe parameters are normally converted to four subframes parameters (e.g., adaptive, fixed, codebook and gain) after reconstructing each parameter. The EVRC has three subframes and SMV has four subframes at the full rate. Linear predictive coefficients (LPC) do not typically change.

Pitch delay, pitch and fixed codebook gain is generally generated using a linear interpolation. Since fixed codebook indices indicate the pulse position, the signal may be divided into four subframe sizes after constructing the fixed codebook signal of frame.

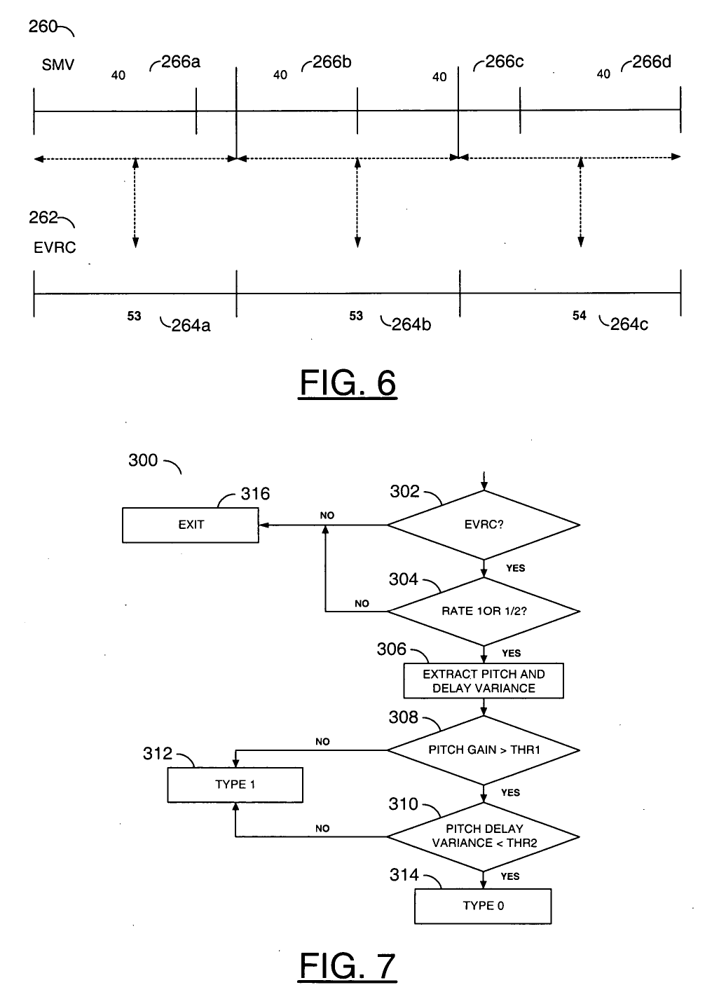

Although the SMV has 6 modes (four rates) and two types (e.g., type 0 and type 1), the EVRC normally processes only 1 mode (with three rates). The circuit 206 implements a suitable mode selection routine. If incoming packet is an EVRC packet, the SMV decoder works in mode 0 (e.g., full, half and eighth rate). In general, the type 1 frame represents a stationary voiced frame and the type 0 frame represents a non-stationary voiced frame. The type 0 frame is assigned more bits for the fixed codebook. A type 1 frame is assigned more bits for the adaptive codebook. An SMV frame normally has a type selection bit in the encoded bit stream. An EVRC encoded bit stream does not normally support the type selection bit. The half rate does not need any additional rate selection because the SMV to the EVRC conversion process works on the type 1 frame (e.g., with a subframe size of 53, 53, and 54—to be described in more detail in connection with FIG. 6). Several codebook contents and a bit parameter may be changed like that of an EVRC type 1 frame.

The block 220 may be configured to generate the pitch excitation signal on a per sub-frame basis. The block 222 may be configured to generate the residual excitation signal on a per sub-frame basis, since the fixed codebook between an EVRC frame and a SMV frame is different. The block 220 normally has two different codebooks, one for SMV encoding and one for EVRC encoding. The method that generates a residual signal may have a similar implementation. The block 224 may be a gain block that should have a scaling operation between EVRC and SMV for the adaptive and fixed codebooks.

The blocks 226, 228, 230, 232 and 234 provide a scaling adjustment for SMV and EVRC gain since SMV and EVRC have different dynamic range and increasing steps of the gain. The blocks 220, 222, 224, 226, 228, 230, 232 and 234 are generally the same as in conventional SMV design, but with the addition of the gain scaling routine.

Referring to FIG. 6, a diagram of an SMV frame 260 is shown compared with an EVRC frame 262. The mapping of frames 260 and 262 is shown between the two vocoder systems. The EVRC frame 262 comprises three subframes 264a-264c, even when operating at full rate. The SMV frame 260 always comprises four subframes 266a-266n. The length of subframes 266a-266d needs to be mapped in order to adjust to the number of subframes 264a-264n. Such mapping is particularly useful at a residual signal. Since the best pulse positions are typically already known for a particular fixed codebook, the length of residual signal can normally be aligned as shown in FIG. 6. First, if an incoming packet is generated from the EVRC, the frame 262 comprises decoded pulse positions of the three subframes 264a-264c (53, 53, 54 samples). And then, the frame 260 comprises four subframes 266a-266d with 40 samples. If SMV encoder needs to generate an EVRC packet 262, then four subframes 266a-266d comprise the three subframes 264a-264c (53, 53, and 54 samples).

Referring to FIG. 7, a type selection method 300 is shown. The method 300 may be used to classify between stationary and non-stationary parameters as well as to distinguish pitch, gain and delay variances. In general, non-stationary frames have smaller gain and a larger variance than stationary frames. The method 300 generally comprises a decision state 302, a decision state 304, a state 306, a decision state 308, a decision state 310, a state 312, a state 314, and a state 316. The decision state 302 determines if the packet is an EVRC packet. If not, the method 300 moves to the state 316 and the process stops. If the packet is an EVRC packet, the method 300 moves to the state 304. The decision state 304 determines if the system 100 is operating at full rate or half rate. If the system 100 is not operating at either full rate or half rate, the method 300 moves to the state 316. If the system 100 is operating at either full rate or half rate, the method 300 moves to the state 306. The state 306 extracts the pitch, gain and delay variance parameters. Next, the state 308 determines if the pitch and gain is greater than a first threshold (e.g., THR1). If not, the method 300 moves to the state 312 which indicates that the packet is a type 1 packet. If the pitch and gain is greater than the first threshold THR1, the method 300 moves to the decision state 310. The decision state 310 determines whether the pitch delay variance is less than a second threshold (e.g., THR2). If so, the method moves to the state 314 which indicates that the packet is a type 0 packet.

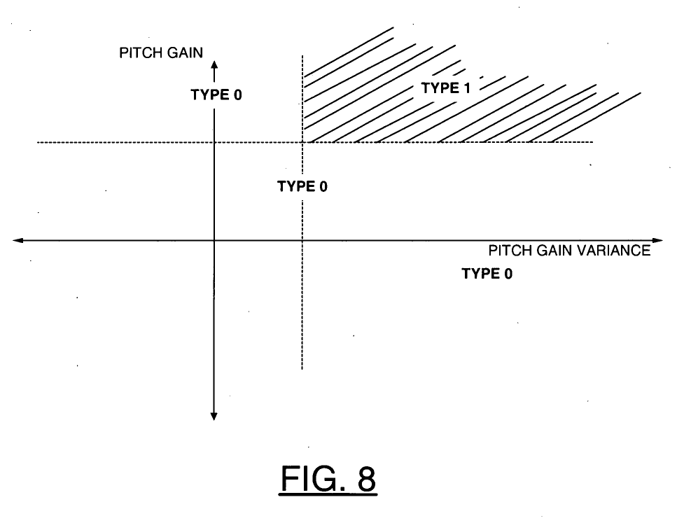

Referring to FIG. 8, a diagram of a two dimensional plot of a type 0 and a type 1 frame is shown. The plot of FIG. 8 illustrates a type 0 and 1 discrimination using two featured parameters. A type 1 frame is chosen when a pitch gain and lag have values greater than one or more predetermined thresholds.

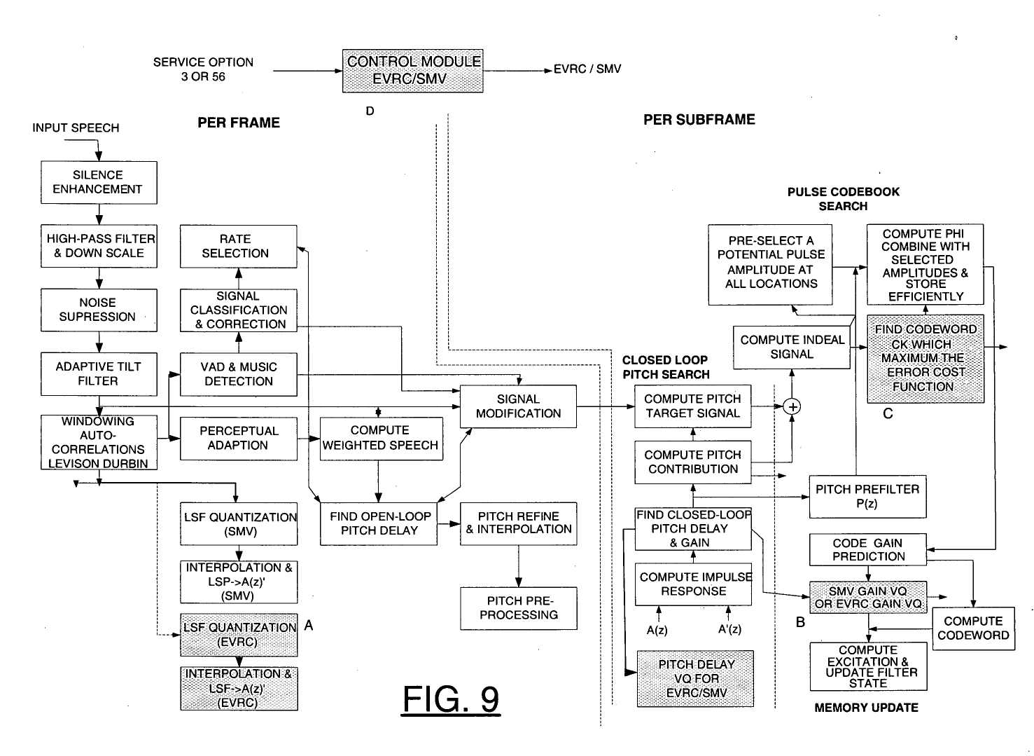

Referring to FIG. 9, a flow diagram of the SMV encoder is shown with a transcoding process. A. An SMV encoder block A has the EVRC LSF codebook and quantization functions because of difference between LSF quantization method of EVRC and that of SMV. After being quantized, the codebook indices are packeted to EVRC packet format.

B. SMV encoder block B has the EVRC gain codebook and quantization functions because of difference between gain quantization method of EVRC and that of SMV. After quantization, the codebook indices are packeted to EVRC packet format.

C. In the mode 1, the SMV should search best pulse position using the breadth first search method by the three different Algebraic codebooks. The EVRC should search for the best pulse position using the depth first search method by the one algebraic codebook having different codebook content. So, the SMV encoder needs to have another search module to search the fixed codebook of EVRC. The fixed codebook module of the SMV encoder should have two (depth first search method for EVRC and breadth first search for SMV) because any common routine between two search methods does not exist.

D. This block controls the transcoding blocks according to the service option.

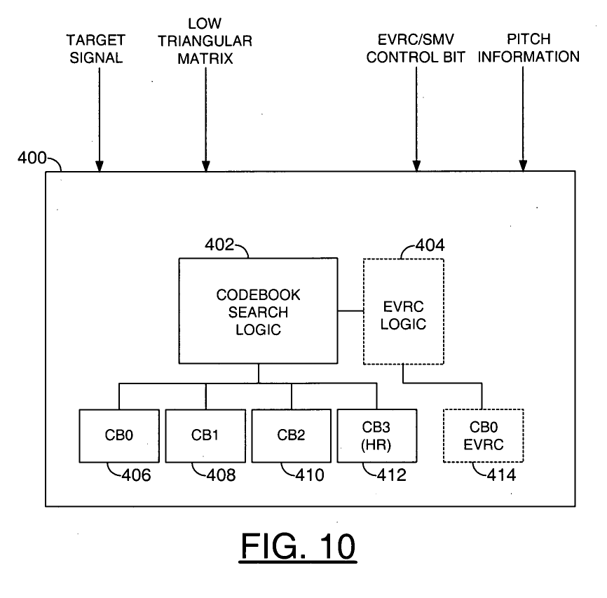

Referring to FIG. 10, a block diagram of a fixed codebook architecture 400 illustrating an SMV encoder with transcoding is shown. The architecture 400 generally comprises a block 402, a block 404, a block 406, a block 408, a block 410, a block 412, and a block 414. The block 402 may be a codebook search logic block. The block 404 may be an EVRC logic block. The block 406, the block 408, the block 410 and the block 412 may be implemented as codebook blocks. The block 414 may be a EVRC codebook block. If a particular encoder works in the EVRC mode, the codebook search logic 402 finds the best pulse positions by using the EVRC logic 404 with EVRC codebook 414 in the residual signal.

In one example, the present invention may be used in a CDMA2000 mobile communication system. In another example, the present invention may be used in worldwide third generation CDMA systems as specified by IS-2000 1X standards. However, the present invention may be easily implemented in other designs.

The function performed by the flow diagram of FIGS. 5, 7 and 9 may be implemented using a conventional general purpose digital computer programmed according to the teachings of the present specification, as will be apparent to those skilled in the relevant art(s). Appropriate software coding can readily be prepared by skilled programmers based on the teachings of the present disclosure, as will also be apparent to those skilled in the relevant art(s).

The present invention may also be implemented by the preparation of ASICs, FPGAs; or by interconnecting an appropriate network of conventional component circuits, as is described herein, modifications of which will be readily apparent to those skilled in the art(s).

The present invention thus may also include a computer product which may be a storage medium including instructions which can be used to program a computer to perform a process in accordance with the present invention. The storage medium can include, but is not limited to, any type of disk including floppy disk, optical disk, CD-ROM, magneto-optical disks, ROMs, RAMs, EPROMs, EEPROMs, Flash memory, magnetic or optical cards, or any type of media suitable for storing electronic instructions.

While the invention has been particularly shown and described with reference to the preferred embodiments thereof, it will be understood by those skilled in the art that various changes in form and details may be made without departing from the spirit and scope of the invention.

1. An apparatus comprising:
an encoder circuit configured to generate a bitstream comprising a series of packets in response to a speech input signal; and
a transcoder circuit configured to generate an intermediate bitstream in response to said bitstream, wherein said transcoder (a) implements (i) a first encoding type comprising a selectable mode voice (SMV) encoding when in a first mode and (ii) a second encoding type comprising an enhanced variable rate (EVR) encoding when in a second mode, in response to a type of data in each of said packets of said bitstream and (b) said first or second encoding type is selected on a per packet basis.

2. The apparatus according to claim 1, further comprising:
a decoder circuit configured to generate a reconstructed data stream in response to said intermediate bitstream.

3. The apparatus according to claim 2, wherein said transcoder is configured to select said first or second encoding type by determining whether each packet is a frame type 0 or a frame 1, wherein said determination is made at ½ rate or at full rate in the decoder.

4. The apparatus according to claim 1, wherein said apparatus implements an EVRC fixed codebook and an SMV fixed codebook in said encoder.

5. The apparatus according to claim 1, wherein said apparatus uses EVRC LSF quantization after one or more SMV LSF parameters are analyzed in the encoder.

6. The apparatus according to claim 1, wherein said apparatus uses an EVRC gain quantization and codebook after an SMV pitch and fixed codebook gain is analyzed.

7. The apparatus according to claim 2, wherein said apparatus selects an incoming EVRC packet in mode 1 in the decoder.

8. The apparatus according to claim 1, wherein said apparatus makes an EVRC packet by using mode 1 in the encoder.

9. The apparatus according to claim 1, wherein said apparatus merges the transcoding circuit into a vocoder block (encoder/decoder).

10. An apparatus comprising:
means for generating a bitstream comprising a series of packets in response to a speech input signal; and
means for generating an intermediate bitstream in response to said bitstream, wherein said means for generating an intermediate bitstream (a) implements (i) a first encoding type comprising a selectable mode voice (SMV) encoding when in a first mode and (ii) a second encoding type comprising an enhanced variable rate (EVR) encoding when in a second mode, in response to a type of data in each of said packets of said bitstream and (b) said first or second encoding type is selected on a per packet basis.

11. A method for transcoding comprising the steps of:
(A) generating a bitstream comprising a series of packets in response to a speech input signal; and
(B) generating an intermediate bitstream in response to said bitstream, wherein step (B) (a) implements (i) a first encoding type comprising a selectable mode voice (SMV) encoding when in a first mode and (ii) a second encoding type comprising an enhanced variable rate (EVR) encoding when in a second mode, in response to a type of data in each of said packets of said bitstream and (b) said first or second encoding type is selected on a per packet basis.

12. The method according to claim 11, further comprising the step of:
generating a reconstructed data stream in response to said intermediate bitstream.

13. The method according to claim 11, wherein said method is configured to select said first or second encoding type by determining whether each packet is a frame type 0 or a frame 1, wherein said determination is made at ½ rate or at full rate.

14. The method according to claim 11, wherein said method implements an EVRC fixed codebook and an SMV fixed codebook in an encoder.

15. The method according to claim 11, wherein said method uses EVRC LSF quantization after one or more SMV LSF parameters are analyzed.

16. The method according to claim 11, wherein said method uses an EVRC gain quantization and codebook after an SMV pitch and fixed codebook gain is analyzed.

17. The method according to claim 11, wherein said method selects an incoming EVRC packet in mode 1.

18. The method according to claim 11, wherein said method makes an EVRC packet by using mode 1.
